(19) United States
(12) Patent Application Publication
(10) Pub. No.: US 2007/0208039 A1
(43) Pub. Date: Sep. 6, 2007

(54) Fungicidal Mixtures for Controlling Rice Pathogens

(76) Inventors: Jordi Tormo i Blasco, Laudenbach (DE); Thomas Grote, Wachenheim (DE); Maria Scherer, Godramstein (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 11/579,662

(22) PCT Filed: Apr. 27, 2005
(86) PCT No.: PCT/EP05/04481

§ 371 Date: Nov. 7, 2006

(30) Foreign Application Priority Data
May 7, 2004 (DE) 102004023160.5

(51) Int. Cl. A01N 43/90; A01N 37/30

(52) U.S. Cl. 514/259.31; 514/554

(57) ABSTRACT

Fungicidal mixtures for controlling ricepathogens, which mixtures comprise, as active components,
1) the triazolopyrimidine derivative of the formula I 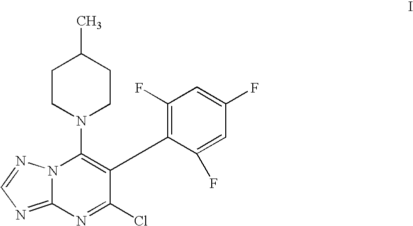 and
2) dodine of the formula II 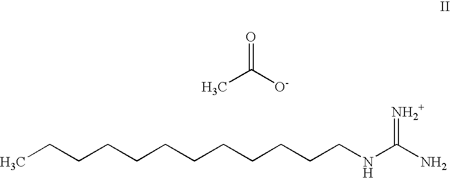 in a synergistically effective amount, methods for controlling rice pathogens using mixtures of the compound I with the compound II, the use of the compound I with the compound II for preparing such mixtures and compositions comprising these mixtures.

The present invention relates to fungicidal mixtures for controlling rice pathogens, which mixtures comprise, as active components,
1) the triazolopyrimidine derivative of the formula I 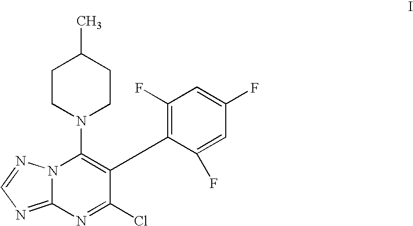
   and
2) dodine of the formula II 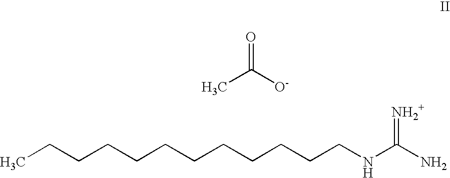
   in a synergistically effective amount.

Moreover, the invention relates to a method for controlling rice pathogens using mixtures of the compound I with the compound II and to the use of the compound I with the compound II for preparing such mixtures and compositions comprising these mixtures.

The compound I, 5-chloro-7-(4-methylpiperidin-1-yl)-6-(2,4,6-trifluorophenyl)-[1,2,4]tri-azolo[1,5-a]pyrimidine, its preparation and its action against harmful fungi are known from the literature (WO 98/46607).

The compound II, 1-dodecylguanidinium acetate, its preparation and its action against harmful fungi are likewise known from the literature (U.S. Pat. No. 2,867,562; common name dodine).

Mixtures of triazolopyrimidine derivatives with dodine are proposed in a general manner in EP-A 988 790. The compound I is embraced by the general disclosure of this publication, but not explicitly mentioned. The combination of compound I with dodine is novel.

The synergistic mixtures known from EP-A 988 790 are described as being fungicidally active against various diseases of cereals, fruit and vegetables, such as mildew on wheat and barley or gray mold on apples.

Owing to the special cultivation conditions of rice plants, the requirements that a rice fungicide has to meet are clearly different from those that fungicides used in cereal or fruit growing have to meet. There are differences in the application method: besides the foliar application used in many places, in modern rice cultivation the fungicide is usually applied directly onto the soil during or shortly after sowing. The fungicide is taken up into the plant via the roots and transported in the sap of the plant to the plant parts to be protected. In contrast, in cereal or fruit growing, the fungicide is usually applied onto the leaves or the fruits; accordingly, in these crops the systemic action of the active compounds is considerably less important.

Moreover, typical rice pathogens are different from those in cereals or fruit. Pyricularia oryzae and Corticium sasakii (syn. Rhizoctonia solani) are the pathogens of the diseases most prevalent in rice plants. Rhizoctonia solani is the only pathogen of agricultural significance from the sub-class Agaricomycetidae. In contrast to most other fungi, this fungus attacks the plant not via spores but via a mycelium infection.

For this reason, findings concerning the fungicidal activity in the cultivation of cereals or fruit cannot be transferred to rice crops.

It is an object of the present invention to provide, with a view to an effective control of rice pathogens at application rates which are as low as possible, mixtures which, at a reduced total amount of active compounds applied, have an improved effect against the harmful fungi.

We have found that this object is achieved by the mixtures defined at the outset. Surprisingly, it has been found that the dodine mixtures definied at the outset allow considerably better control of rice pathogens than the dodine mixtures of the triazolopyrimidine compounds known from EP-A 988 790. Moreover, we have found that simultaneous, that is joint or separate, application of the compound I and the compound II or successive application of the compound I and the compound II allows better control of rice pathogens than is possible with the individual compounds.

When preparing the mixtures, it is preferred to employ the pure active compounds I and II, to which further active compounds against harmful fungi or other pests, such as insects, arachnids or nematodes, or else herbicidal or growth-regulating active compounds or fertilizers can be added as required.

Further suitable active compounds in the above sense are, in particular, fungicides selected from the following group:
acylalanines, such as benalaxyl, metalaxyl, ofurace, oxadixyl,
amine derivatives, such as aldimorph, dodemorph, fenpropimorph, fenpropidin, guazatine, iminoctadine, spiroxamine, tridemorph,
anilinopyrimidines, such as pyrimethanil, mepanipyrim or cyprodinil,
antibiotics, such as cycloheximide, griseofulvin, kasugamycin, natamycin, polyoxin or streptomycin,
azoles, such as bitertanol, bromoconazole, cyproconazole, difenoconazole, dinitroconazole, enilconazole, epoxiconazole, fenbuconazole, fluquinconazole, flusilazole, flutriafol, hexaconazole, imazalil, ipconazole, metconazole, myclobutanil, penconazole, propiconazole, prochloraz, prothioconazole, simeconazole, tebuconazole, tetraconazole, triadimefon, triadimenol, triflumizole, triticonazole,
dicarboximides, such as iprodione, myclozolin, procymidone, vinclozolin,
dithiocarbamates, such as ferbam, nabam, maneb, mancozeb, metam, metiram, propineb, polycarbamate, thiram, ziram, zineb,
heterocyclic compounds, such as anilazine, benomyl, boscalid, carbendazim, carboxin, oxycarboxin, cyazofamid, dazomet, dithianon, famoxadone, fenamidone, fenarimol, fuberidazole, flutolanil, furametpyr, isoprothiolan, mepronil, nuarimol, penthiopyrad, picobenzamid, probenazole, proquinazid, pyrifenox, pyroquilon, quinoxyfen, silthiofam, thiabendazole, thifluzamide, thiophanate-methyl, tiadinil, tricyclazole, triforine,
copper fungicides, such as Bordeaux mixture, copper acetate, copper oxychloride, basic copper sulfate,
nitrophenyl derivatives, such as binapacryl, dinocap, dinobuton, nitrophthal-isopropyl,
phenylpyrroles, such as fenpiclonil or fludioxonil,
sulfur,
other fungicides, such as acibenzolar-S-methyl, benthiavalicarb, carpropamide, chlorothalonil, cyflufenamide, cymoxanil, diclomezin, diclocymet, diethofencarb, edifenphos, ethaboxam, fenhexamide, fentin acetate, fenoxanil, ferimzone, fluazinam, fosetyl, fosetyl aluminum, iprovalicarb, hexachlorobenzene, mandipropamid metrafenon, pencycuron, propamocarb, phosphorous acid, phthalide, toloclofos-methyl, quintozene, zoxamide,
strobilurins, such as azoxystrobin, dimoxystrobin, enestroburin, fluoxastrobin, kresoxim-methyl, metominostrobin, orysastrobin, picoxystrobin, pyraclostrobin or trifloxystrobin,
sulfenic acid derivatives, such as captafol, captan, dichlofluanid, folpet, tolylfluanid,
cinnamides and analogs, such as dimethomorph, flumetover or flumorph.

In one embodiment of the mixtures according to the invention, the compounds I and II are mixed with a further fungicide III or two fungicides III and IV.

Preference is given to mixtures of the compounds I and II and a component III. Particular preference is given to mixtures of the compounds I and II.

The mixtures of the compounds I and II or the simultaneous (joint or separate) use of the compound I and the compound II are distinguished by an outstanding effectiveness against rice pathogens from the class of the Ascomycetes, Deuteromycetes and Basidiomycetes. They have high systemic activity and can therefore be employed for seed dressing, and also as foliar and soil fungicides.

They are of particular importance for the control of harmful fungi on rice plants and seeds thereof, such as Bipolaris and Drechslera species, and also Pyricularia oryzae. They are particularly suitable for controlling sheath blight of rice caused by Corticium sasakii.

Moreover, the inventive combination of compounds I and II is also suitable for controlling other pathogens, such as, for example, Septoria, Phahopsora and Puccinia species in soy beans and cereals and Alternaria and Botrytis species in vegetables, fruit and grapevines.

The compound I and the compound II can be applied simultaneously, that is jointly or separately, or in succession, the sequence, in the case of separate application, generally not having any effect on the result of the control measures.

The compound I and the compound II are usually applied in a weight ratio of from 100:1 to 1:100, preferably from 2:1 to 1:20, in particular from 1:1 to 1:15.

The components III and IV are added if required in a ratio of from 20:1 to 1:20 with respect to the compound I.

Depending on the type of the compound and of the desired effect, the application rates of the mixtures according to the invention are from 0.1 kg/ha to 3 kg/ha, preferably from 0.5 to 2 kg/ha.

Correspondingly, the application rates for the compound I are generally from 1 to 1000 g/ha, preferably from 10 to 900 g/ha, in particular from 20 to 750 g/ha.

Correspondingly, the application rates for the compound II are generally from 0.1 to 3 kg/ha, preferably from 0.5 to 2 kg/ha, in particular from 1 to 1.5 kg/ha.

In the treatment of seed, application rates of mixture of generally from 1 to 1000 g/100 kg of seed, preferably from 1 to 200 g/100 kg, in particular from 5 to 100 g/100 kg, are used.

In the control of pathogenic harmful fungi, the separate or joint application of the compounds I and II or of the mixtures of the compounds I and II is carried out by spraying or dusting the seeds, the seedlings, the plants or the soil before or after sowing of the plants or before or after emergence of the plants. The application is preferably performed by spraying the leaves. Joint or separate application of the compounds can also be carried out by applying granules or by dusting the soil.

The mixtures according to the invention, or the compounds I and II, can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers, such as ground natural minerals (for example kaolins, clays, talc, chalk) and ground synthetic minerals (for example highly disperse silica, silicates); emulsifiers, such as nonionogenic and anionic emulsifiers (for example polyoxyethylene fatty alcohol ethers, alkylsulfonates and arylsulfonates), and dispersants, such as lignosulfite waste liquors and methylcellulose.

Suitable surfactants are alkali metal, alkaline earth metal and ammonium salts of lignosulfonic acid, naphthalenesulfonic acid, phenolsulfonic acid, dibutyinaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol and nonylphenol, alkylphenyl polyglycol ethers, tributylphenyl polyglycol ethers, tristearylphenyl polyglycol ethers, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone or water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths, such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to the NMR spectrum).

The following are examples of formulations: 1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifying machine (Ultraturrax) and made into a homogeneous emulsion. Dilution with water gives an emulsion.

E) Suspensions (SC, OD)

In an agitated ball mill, 20 parts by weight of the active compounds are comminuted with addition of dispersants, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and prepared as water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersants, wetters and silica gel. Dilution with water gives a stable dispersion or solution of the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and combined with 95.5% of carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents can be admixed with the compositions according to the invention typically in a weight ratio of from 1:10 to 10:1.

The compounds I and II or the mixtures or the corresponding formulations are applied by treating the harmful fungi or the plants, seeds, soils, areas, materials or spaces to be kept free therefrom with a fungicidally effective amount of the mixture or, in the case of separate application, of the compounds I and II. Application can be carried out before or after infection by the harmful fungi.

The fungicidal action of the compound and of the mixtures may be revealed by the following tests:

The active compounds, separately or jointly, were prepared as a stock solution comprising 0.25% by weight of active compound in acetone or DMSO. 1% by weight of the emulsifier Uniperol® EL (wetting agent having emulsifying and dispersing action based on ethoxylated alkylphenols) was added to this solution, and the mixture was appropriately diluted with water to the desired concentration.

Use example—activity against brown spot of rice caused by Cochliobolus miyabeanus, protective treatment

Leaves of potted rice seedlings of the cultivar “Tai-Nong 67” were sprayed to runoff point with an aqueous suspension having the concentration of active compound stated below. The next day, the plants were inoculated with an aqueous spore suspension of Cochliobolus miyabeanus. The test plants were then placed in climatized chambers at 22-24° C. and 95-99% relative atmospheric humidity for six days. The extent of the development of the infection on the leaves was then determined visually.

Evaluation is carried out by determining the percentage of infected leaf areas. These percentages were converted into efficacies.

The efficacy (E) is calculated as follows using Abbot's formula:
E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants are not infected.

The expected efficacies of mixtures of active compounds are determined using Colby's formula (Colby, R. S., Weeds, 15, 20-22, 1967) and compared with the observed efficacies.

Colby's formula:
E=x+y−x·y/100
E expected efficacy, expressed in % of the untreated control, when using the mixture of the active compounds A and B at the concentrations a and b
x efficacy, expressed in % of the untreated control, when using the active compound A at the concentration a
y efficacy, expressed in % of the untreated control, when using the active compound B at the concentration b

The comparative compounds used were compounds A and B which are known from the mixtures described in EP-A 988 790:

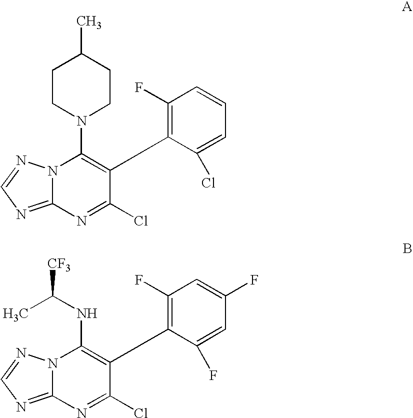

TABLE A
individual active compounds

| | | Concentration | Efficacy in |
|---|---|---|---|
| | | of active | % of the |
| | Active | compound in the | untreated |
| Example | compound | spray liquor [ppm] | control |
| 1 | control | — | (90% |
| | (untreated) | | infection) |
| 2 | I | 6.25 | 56 |
| 3 | II (dodine) | 6.25 | 0 |
| | | 25 | 0 |
| 4 | comparative | 6.25 | 33 |
| | compound A | | |
| 5 | comparative | 6.25 | 56 |
| | compound B | | |

TABLE B
mixtures according to the invention

| | Mixture of | | |
|---|---|---|---|
| | active compounds | | |
| | Concentration | Observed | Calculated |
| Example | Mixing ratio | efficacy | efficacy*) |
| 6 | I + II | 83 | 56 |
| | 6.25 + 6.25 ppm | | |
| | 1:1 | | |
| 7 | I + II | 97 | 56 |
| | 6.25 + 25 ppm | | |
| | 1:4 | | |

*)efficacy calculated using Colby's formula

TABLE C
comparative tests

| | Mixture of | | |
|---|---|---|---|
| | active compounds | | |
| | Concentration | Observed | Calculated |
| Example | Mixing ratio | efficacy | efficacy*) |
| 8 | A + II | 44 | 33 |
| | 6.25 + 6.25 ppm | | |
| | 1:1 | | |
| 9 | A + II | 56 | 33 |
| | 6.25 + 25 ppm | | |
| | 1:4 | | |
| 10 | B + II | 56 | 56 |
| | 6.25 + 6.25 ppm | | |
| | 1:1 | | |
| 11 | B + II | 56 | 56 |
| | 6.25 + 25 ppm | | |
| | 1:4 | | |

*)efficacy calculated using Colby's formula

The test results show that, by virtue of strong synergism, the mixtures according to the invention are, even at low application rates, significantly more effective against brown spot than the dodine mixtures, proposed in EP-A 988 780, of the comparative compounds.

1-10. (canceled)

11. A fungicidal mixture comprising
1) the triazolopyrimidine of the formula I 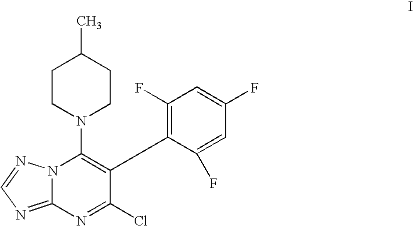
and
2) dodine of the formula II 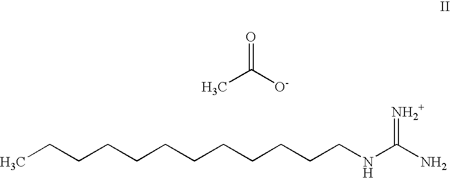
in a synergistically effective amount.

12. The fungicidal mixture according to claim 11, comprising the compound of the formula I and the compound of the formula II in a weight ratio of from 100:1 to 1:100.

13. A composition, comprising a liquid or solid carrier and a mixture according to claim 11.

14. A method for controlling harmful fungi which are rice pathogens, which comprises treating the fungi, their habitat or the seed, the soil or the plants to be protected against fungal attack with all effective amount of the compound I and the compound II as set forth in claim 11.

15. The method according to claim 14, wherein the compounds I and II are applied simultaneously, that is jointly or separately, or in succession.

16. The method according to claim 14, wherein the harmful fungus Cochliobolus miyabeanus is controlled.

17. The method according to claim 14, wherein the compounds I and II or the mixture are/is applied in an amount of from 0.1 g/ha to 3 kg/ha.

18. The method according to claim 14, wherein the compounds I and II or the mixture are/is applied in an amount of from 1 to 1000 g/100 kg of seed.

19. Seed, comprising the mixture according to claim 11 in an amount of from 1 to 1000 g/100 kg.

20. The use of the compounds I and II as set forth in claim 11 for preparing a composition suitable for controlling harmful fungi.

21. A composition, comprising a liquid or solid carrier and a mixture according to claim 12.

22. The method according to claim 15, wherein the harmful fungus Cochliobolus miyabeanus is controlled.

23. The method according to claim 15, wherein the compounds I and II or the mixture are/is applied in an amount of from 0.1 g/ha to 3 kg/ha.

24. The method according to claim 16, wherein the compounds I and II or the mixture are/is applied in an amount of from 0.1 g/ha to 3 kg/ha.

25. The method wherein the compounds I and II as set forth in claim 11 or the mixture are/is applied in an amount of from 0.1 g/ha to 3 kg/ha.

26. The method wherein the compounds I and II or the mixture according to claim 11 are/is applied in an amount of from 0.1 g/ha to 3 kg/ha.

27. The method wherein the compounds I and II or the mixture according to claim 12 are/is applied in an amount of from 0.1 g/ha to 3 kg/ha.

28. The method according to claim 15, wherein the compounds I and II or the mixture are/is applied in an amount of from 1 to 1000 g/100 kg of seed.

29. The method according to claim 16, wherein the compounds I and II or the mixture are/is applied in an amount of from 1 to 1000 g/100 kg of seed.

30. The method wherein the compounds I and II as set forth in claim 11 or the mixture are/is applied in an amount of from 1 to 1000 g/100 kg of seed.
